(19) United States
(12) Patent Application Publication
(10) Pub. No.: US 2025/0130345 A1
(43) Pub. Date: Apr. 24, 2025

(54) STUD FINDER AND MARKER SYSTEM

(71) Applicant: Aacraft, inc., GEORGETOWN, TX (US)

(72) Inventor: SHARI Michelle Hammond, GEORGETOWN, TX (US)

(73) Assignee: Aacraft, inc., GEORGETOWN, TX (US)

(21) Appl. No.: 18/908,849

(22) Filed: Oct. 8, 2024

Related U.S. Application Data
(60) Provisional application No. 63/545,159, filed on Oct. 21, 2023.

(51) Int. Cl. G01V 3/08

(52) U.S. Cl. CPC G01V 3/08

(57) ABSTRACT

A device may include a thin flat polypropylene strip with a pinch point designed for pendulum motion. A device may include a ring magnet positioned at a lower end of the strip to detect the presence of metal fasteners in a stud hidden behind a wall. Magnetic markers are placed to mark the position of a hidden screw in a stud behind the wall.

### CROSS REFERENCE TO RELATED APPLICATION

This application claims priority from U.S. Provisional Patent Application No. 63/545,159 filed on Oct. 21, 2023, entitled “A Stud Finder and Marker System” by Shari Michelle Hammond, which is hereby incorporated by reference.

### BACKGROUND OF THE INVENTION

The most common wall construction in home building is sheetrock panels nailed or screwed to vertical wood or metal studs. The studs are typically spaced 6 to 24 inches apart. The screws or nails are recessed, and the void is filled with putty then sanded, textured, and painted to create a seamless wall surface. However, later when hanging pictures, mirrors, or shelves on the wall, it is structurally desirable to know where the hidden studs are located. Thus there is a need for a stud finder to find the hidden studs.

### FIELD OF THE INVENTION

The field of the invention relates to a stud finder.

### SUMMARY OF THE INVENTION

An apparatus for finding a stud, the apparatus including but not limited to a thin flat polypropylene strip 4 with a pinch point 11 for pendulum swinging strip; a ring magnet at a lower end of strip 4 is a ring magnet 6; and a snap-on cap 5 at the lower end of strip 4 is a ring magnet 6. A method for finding a stud, including but not limited to rotating a magnetic pendulum strip 4 and swing the rotating magnetic pendulum strip back and forth across a section of sheetrock with the magnet 6 towards the wall until the magnet 6 is magnetically attracted a screw 9; and replacing the magnet 6 with a magnetic nail marker.

### BRIEF DESCRIPTION OF THE DRAWINGS

The drawings presented herein are for illustrative purposes only and do not limit the scope of the claims. Rather, the drawings are intended to help enable one having ordinary skill in the art to make and use the claimed inventions. The drawings are drawn to scale.

FIG. 1 shows a thin flat polypropylene strip with a pinch point for pendulum swinging strip;

FIG. 2 shows a cross section of sheetrock and stud;

FIG. 3 shows stud finder folded for convenient storage and/or packaging; and

FIG. 4 shows a magnetic nail marker;

FIG. 5 shows a plan view, side view and perspective view and a section A-A of the stud finder; and

FIG. 6 shows an exploded view of the stud finder.

### DETAILED DESCRIPTION OF THE INVENTION

A detailed description will now be provided. The purpose of this detailed description, which includes the drawings, is to satisfy the statutory requirements of 35 U.S.C. § 112. For example, the detailed description includes a description of inventions defined by the claims and sufficient information that would enable a person having ordinary skill in the art to make and use the inventions. In the figures, like elements are generally indicated by like reference numerals regardless of the view or figure in which the elements appear. The figures are intended to assist the description and to provide a visual representation of certain aspects of the subject matter described herein. The figures are not all necessarily drawn to scale, nor do they show all the structural details, nor do they limit the scope of the claims.

Each of the appended claims defines a separate invention which, for infringement purposes, is recognized as including equivalents of the various elements or limitations specified in the claims. Depending on the context, all references below to the “invention” may in some cases refer to certain specific embodiments only. In other cases, it will be recognized that references to the “invention” will refer to the subject matter recited in one or more, but not necessarily all, of the claims. Each of the inventions will now be described in greater detail below, including specific embodiments, versions, and examples, but the inventions are not limited to these specific embodiments, versions, or examples, which are included to enable a person having ordinary skill in the art to make and use the inventions when the information in this patent is combined with available information and technology. Various terms as used herein are defined below, and the definitions should be adopted when construing the claims that include those terms, except to the extent a different meaning is given within the specification or in express representations to the Patent and Trademark Office (PTO). To the extent a term used in a claim is not defined below or in representations to the PTO, it should be given the broadest definition persons having skill in the art have given that term as reflected in at least one printed publication, dictionary, or issued patent.

Certain specific embodiments of methods, structures, elements, and parts are described below, which are by no means an exclusive description of the inventions. Other specific embodiments, including those referenced in the drawings, are encompassed by this application and any patent that issues therefrom.

A simple but effective stud finder system for locating then marking fasteners hidden underneath a plastered sheetrock surface. The most common wall construction in home building is sheetrock panels nailed or screwed to vertical wood or metal studs. The studs are typically spaced 6 to 24 inches apart. The screws or nails are recessed, and the void is filled with putty then sanded, textured, and painted to create a seamless wall surface. However, later when hanging pictures, mirrors, or shelves on the wall, it is structurally desirable to know where the hidden studs are located.

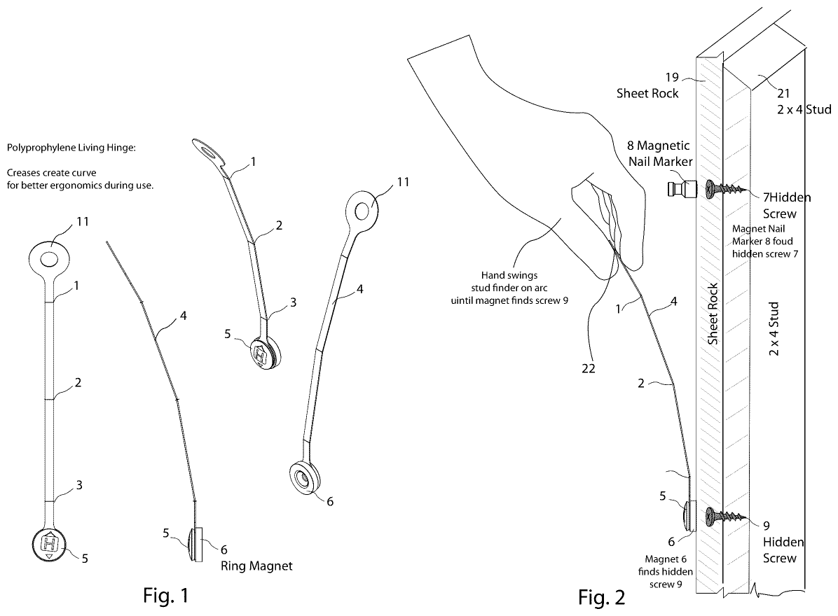

FIG. 1 shows a thin flat polypropylene pendulum swinging strip 4 with an anchor or pinch point 11 for the pendulum swinging strip 4. At the lower end of strip 4 is a ring magnet 6 and a snap-on cap 5. A logo can be printed on snap 5 if desired. Creases at 1, 2, and 3 serve as a “living hinges” in the swinging strip 4 creating a curve for better ergonomics during use.

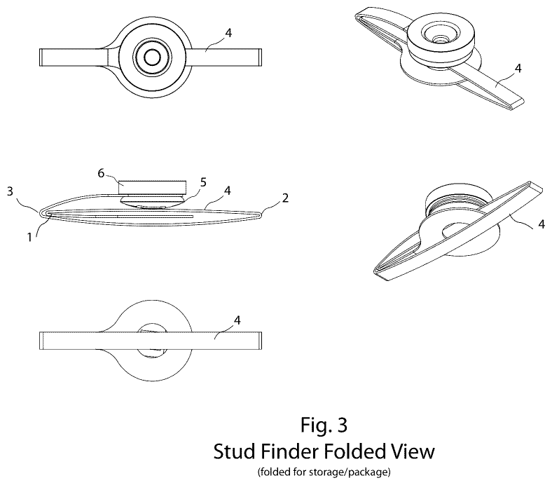

FIG. 2 shows a cross section of sheetrock 19 and stud 21. Hidden screws 7 and 9 have been covered with plaster and are invisible to the eye. Screws 7, 9 and many others are holding sheetrock to the studs. To find a hidden screw 9, the users fingers rotate the magnetic pendulum strip 4 and swing it back and forth across the sheetrock with the magnet 6 towards the wall until the magnet 6 is magnetically attracted to a hidden screw 9. At this point a magnetic nail marker 8 replaces the magnet 6 at the location of the hidden screw and the search for another screw/stud can begin. The magnetic markers are positioned over the hidden screw(s) and remain in place at each found stud sites. As more screws/studs are found, you will see patterns and be able to predict where the studs are located behind the sheetrock.

FIG. 3 shows stud finder 4 folded at hinges 1, 2 and 3 for convenient storage and/or packaging.

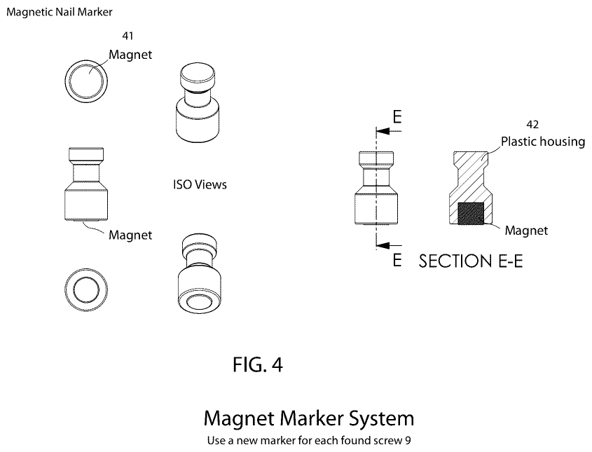

FIG. 4 shows a magnetic nail marker. The marker resembles a push pin marker only a magnet replaces the metal pin so that the marker is attached to the hidden screw and can be used to mark the hidden screw. The marker is made up of a plastic housing 42 and a magnet 41 placed in the bottom of the plastic housing.

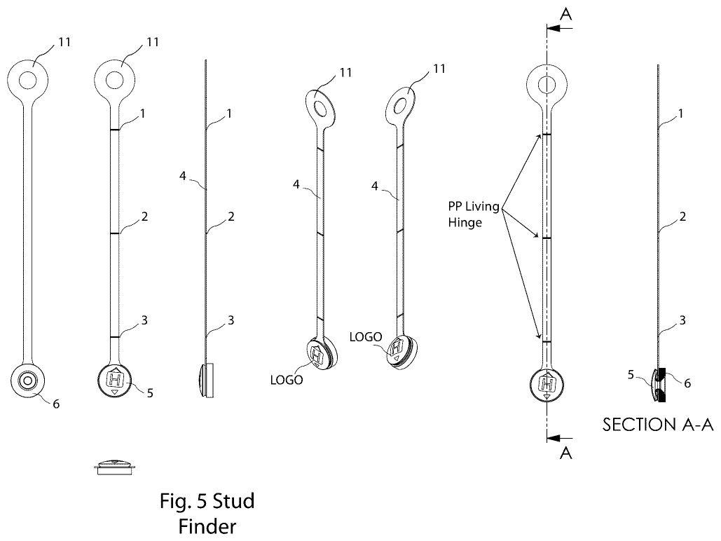

FIG. 5 shows a plan view, side view and perspective view and a section A-A of the stud finder.

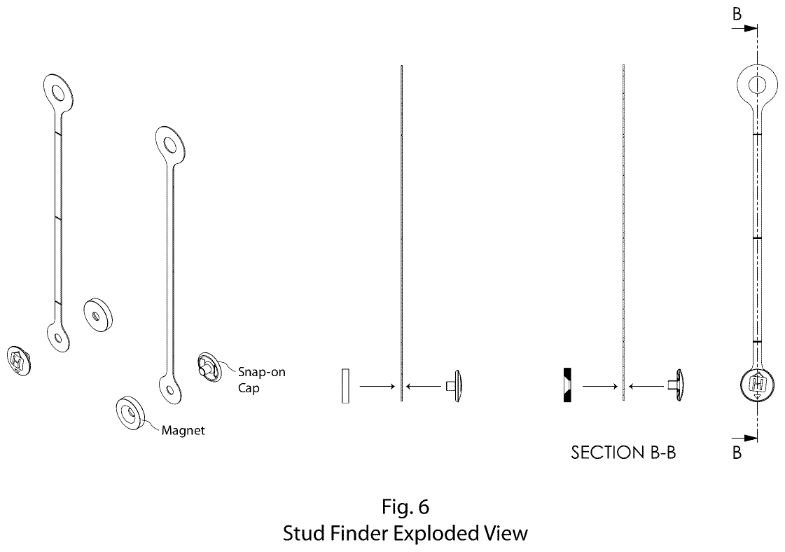

FIG. 6 shows an exploded view of the stud finder.

In some aspects, the techniques described herein relate to an apparatus for finding a stud, the apparatus including but not limited to a thin flat polypropylene strip 4 with a pinch point 11 for pendulum swinging strip; a ring magnet at a lower end of strip 4 is a ring magnet 6; and a snap-on cap 5 at the lower end of strip 4 is a ring magnet 6.

In some aspects, the techniques described herein relate to an apparatus, further including but not limited to creases at 1, 2, and 3 serve as “living hinges” creating a curve for better ergonomics during use.

In some aspects, the techniques described herein relate to a method, the method including but not limited to a rotating a magnetic pendulum strip 4 and swing the rotating magnetic pendulum strip back and forth across a section of sheetrock with the magnet 6 towards the wall until the magnet 6 is magnetically attracted a screw 9; and replacing the magnet 6 with a magnetic nail marker.

In some aspects, the techniques described herein relate to a method, further including but not limited to searching for another screw/stud; and leaving magnetic markers at each found stud sites.

In some aspects, the techniques described herein relate to an apparatus for locating a stud, including: a thin flat polypropylene strip with a pinch point designed for pendulum motion; and a ring magnet positioned at a lower end of the strip to detect the presence of metal fasteners.

In some aspects, the techniques described herein relate to an apparatus for locating a stud, further including: a magnetic marker for making a location of the metal fastener.

In some aspects, the techniques described herein relate to an apparatus for locating a stud, further including: a snap-on cap at the lower end of the strip, also containing the ring magnet.

In some aspects, the techniques described herein relate to an apparatus or locating a stud, further including creases positioned at designated points along the strip, functioning as living hinges to facilitate ergonomic movement during use.

In some aspects, the techniques described herein relate to a method for locating a stud, including rotating a ring magnet on a lower end of a pendulum strip back and forth across a wall surface; and detecting the presence of a hidden fastener using the magnetic attraction of the ring magnet to the hidden fastener; and

In some aspects, the techniques described herein relate to a method for locating a stud, further including replacing the magnet at the detected location with a magnetic nail marker.

In some aspects, the techniques described herein relate to a method, further including continuing the search for additional fasteners or studs; and leaving magnetic nail markers at each detected stud location for future reference.

1. An apparatus for locating a stud, comprising:
a thin flat polypropylene strip with a pinch point designed for pendulum motion; and
a ring magnet positioned at a lower end of the strip to detect the presence of metal fasteners for locating a metal fastener in a stud hidden behind a wall.

2. The apparatus for locating a stud, of claim 1, further comprising:
a magnetic marker for making a location of the metal fastener.

3. The apparatus for locating a stud, of claim 1, further comprising:
a snap-on cap at the lower end of the strip, also containing the ring magnet.

4. The apparatus or locating a stud, of claim 1, further comprising:
creases positioned at designated points along the strip, functioning as living hinges to facilitate ergonomic movement during use.

5. A method for locating a stud, comprising:
rotating a ring magnet on a lower end of a pendulum strip back and forth across a wall surface; and
detecting the presence of a hidden metal fastener in a stud, using the magnetic attraction of the ring magnet to the hidden fastener.

6. The method for locating a stud of claim 5, further comprising:
replacing the magnet at the detected location with a magnetic marker.

7. The method of claim 6, further comprising:
continuing the search for additional fasteners or studs; and
leaving magnetic markers at each detected stud location for future reference.
